(19) United States
(12) Patent Application Publication
(10) Pub. No.: US 2024/0230824 A9
(43) Pub. Date: Jul. 11, 2024

(54) PRECISE POSITIONING METHOD IN ENVIRONMENT WITHOUT POSITIONING INFRASTRUCTURE USING ULTRA-WIDEBAND

(71) Applicant: RAON Convergence, Co. Ltd., Daejeon (KR)

(72) Inventors: Chan Ku KANG, Daejeon (KR); Young Gwan KIM, Daejeon (KR)

(21) Appl. No.: 17/975,698

(22) Filed: Oct. 28, 2022

(30) Foreign Application Priority Data
Oct. 20, 2022 (KR) 10-2022-0135615

(51) Int. Cl. G01S 5/02; H04W 64/00

(52) U.S. Cl. CPC G01S 5/02216; G01S 5/0226; H04W 64/003

(57) ABSTRACT

A method using a UWB for precisely positioning in an environment without a positioning infrastructure is provided. The method, when positioning objects of swarm objects in a free space, etc., calculates an object position of each object through cooperation with objects existing surrounding. In this state, positioning is simply performed without a specific anchor by defining objects as anchors in a UWB in accordance with an embodiment. In particular, cooperative positioning is quickly performed by reducing position errors of objects in accordance with pull-push relationships based on UWB TWR. Therefore, when a specific mission is performed in an environment in which a positioning infrastructure does not exist or is lost, such as a flight space, positioning is performed in the UWB-based cooperative positioning method described above, whereby precise positioning suitable for these environments is provided.

### CROSS REFERENCE TO RELATED APPLICATION

The present application claims priority to Korean Patent Application No. 10-2022-0135615, filed Oct. 20, 2022, which is incorporated herein by reference in its entirety.

### BACKGROUND

### 1. Technical Field

The present disclosure relates to a precise positioning method in an environment without a positioning infrastructure. In more detail, the present disclosure relates to a method of smoothly performing positioning by appropriately positioning an object in various environment in which there a positioning infrastructure (particularly, an access point (AP)) does not exist or is lost, for example, when a flight space or swarm flight of moving bodies is required or specific work is performed in accident sites.

### 2. Description of the Related Art

Unless stated otherwise in this specification, the contents described in this section are not the related art about the claims of this application and not all of the contents included in this section are regarded as the related art.

In general, as environments in which a positioning infrastructure does not exist or is relatively difficult to install, there are a harbor and a flight space, the underground, accident and disaster sites, etc. Further, positioning methods that are suitable for environments without such positioning infrastructure are still usually used at accident sites or in an indoor environment.

Meanwhile, the demands for various flying objects such as a popular flying object, a super-small flying object, etc. are greatly increasing with the rapid development of the flying object technology. In this situation, there is study that several flying objects fly while forming a formation group to improve performance of unmanned flying objects.

Further, there is also research about unmanned flying objects. Unmanned flying objects are recently used for various purposes such as leisure of common people, filming, etc. Recently, rather than simple unmanned flight of a single flying object, swarm flight of one or more flying objects that perform specific work such as disaster relief while forming a formation is being studied.

However, the technology of positioning such unmanned flying objects is considered as not overcoming the limit of high density swarm flight and a technology of positioning swarm flying objects using a UWB is not applied yet.

Further, position information is important to remotely control swarm moving bodies, for example, multi-robots that perform rescuing and probing work in accident sites. However, in accident sites, a positioning infrastructure is lost, and the poisoning accuracy of a tunnel, etc. to be probed is considerably low.

In more detail, an ultra-wideband (UWB) communication technology has an ultra-wideband occupied bandwidth over about 500 MHz for each channel within the range of given emission limit power and an entire band range. Further, a fractional bandwidth (a bandwidth corresponding to a center frequency) is 20% or more.

Accordingly, the ultra-wideband communication technology has a relatively low spectrum power density throughout a wide frequency band in comparison to the existing narrow band or wide hand CDMA system, so it can be used with existing facilities.

Further, the ultra-wideband communication technology is strong against channel fading and is strong against multiple paths because the bandwidth of the signal is large.

Such a positioning technology using a UWB is in a quickening step and the positioning object is changing into outdoor positioning from indoor positioning.

Accordingly, it would be possible to perform positioning smoothly and quickly by measuring a position by connecting a UWB with an existing cooperative method with an object existing around in a free space, etc.

However, such positioning methods that use a UWB are fundamentally use an anchor, in which a tag estimates a distance using an anchor list, which is transmitted from a base station, while communicating with the base station, thereby performing positioning.

For example, two-way ranging (TWR)-based positioning is one of these methods measures the distance between two nodes using round trip time (RTT). Further, the method does not need visual synchronization, so the method is a technique suitable for a swarm cooperative positioning method.

However, since the TWR-based positioning in the related art calculate the position of a tag using an anchor installed at a fixed position, a multi-path error, clock offset between an anchor and a tag, TWR measurement resolution, etc. cause errors.

Further, since an anchor should be installed at a known position, it is difficult to install a net, it is required to reinstall or rearrange the anchor in order to change a positioning environment, and when the anchor is damaged, it is required to repair and maintain the damaged anchor.

Accordingly, for positioning suitable for a free space, there is a need for a new method that can replace such an infrastructure environment or can quickly position many surrounding targets in a free space without configuring a specific infrastructure.

Meanwhile, as a new method for this purpose, a TWR-based cooperative positioning method has been proposed for the case in which an infrastructure is lost.

However, according to this method, when a mobile terminal designated as a tag calculates positions by obtaining distances from mobile terminals designated anchors, the position errors of the anchors are accumulated as the position error of the tag.

For reference, in the related art, there was an angle of arrival (AOA)-based cooperative method that calculates relative distance and angle using a laser and a photo detector.

For reference, the following document has been known as the prior art of this background.

(Patent document 0001) KR1020150041240 B1

For reference, the document 1 relates to a method of measuring a position in an environment without an infrastructure, and performs positioning through cooperation of surrounding mobile nodes, so it is less limited in space and range of a positioning space.

In detail, the method changes a tag node or an anchor node, a transmission node, and a reception node on the basis of an instruction from a base station, and estimates the position of a mobile node on the basis of information received from a mobile node or information received from the base station.

### SUMMARY

An objective of the present disclosure is to provide a precise positioning method in an environment without a positioning infrastructure using a UWB, the method perform precise tracking by measuring a position on the basis of a UWB in a free space, that is, an environment in which a positioning infrastructure does not exist or is lost, when performing work in a free space, etc.

This method enables quick cooperative positioning by reducing position errors of many surrounding objects in a free space, etc.

A precise positioning method in an environment without a positioning infrastructure using UWB, first, as in the related art, when a target, that is, an object adjacent to swarm objects in a free space, calculates an object position of an object through cooperation with objects existing surrounding.

In this state, positioning is simply performed without a specific anchor by defining objects as anchors in a UWB in accordance with an embodiment.

In particular, cooperative positioning is quickly performed by reducing position errors of objects in accordance with a pull-push relationship based on UWB Two Way Ranging (TWR).

This cooperative positioning is fundamentally as follows.

First, reference position coordinates are set, a pulling signal is transmitted by preset pull-push relationships according to the TWR of objects around a swarm object, and pushing signals are received from the surrounding objects, whereby ranging is performed.

Thereafter, the object calculates its relative position around the reference position coordinates on the basis of the ranged pull-push relationship and TWR time information. Further, relative positions of surrounding objects are generally calculated on the basis of a Received Signal Strength Indicator (RSSI) and Time of Arrival (ToA) information.

according to embodiments, when specific work is performed in a free space or an environment in which a positioning infrastructure does not exist or is lost, such as an accident site, positioning is performed in the UWB-based cooperative positioning type described above, thereby providing precise positioning.

Accordingly, multi-path tracking and cooperative positioning that are suitable for these various environments, in which a positioning infrastructure does not exist or is lost, are provided, and installing and using are easily achieved in cooperation with existing facilities.

Further, position errors of targets existing around in a free space, etc. are reduced, whereby quick cooperative positioning is provided.

### BRIEF DESCRIPTION OF THE DRAWINGS

FIGS. 1 to 3 are diagrams conceptually illustrating a precise positioning method in an environment without a positioning infrastructure using a UWB according to an embodiment of the present disclosure;

FIG. 4 is a diagram showing the entirety of a system employing the precise positioning method in an environment without a positioning infrastructure using a UWB according to an embodiment;

FIG. 5 is a block diagram showing the configuration of an object applied to the precise positioning method in an environment without a positioning infrastructure using a UWB according to an embodiment;

FIG. 6 is a flowchart sequentially showing the precise positioning method in an environment without a positioning infrastructure using a UWB; and

FIG. 7 is a diagram illustrating a precise position method in an environment without a positioning infrastructure using a UWB according to another embodiment of the present disclosure.

### DETAILED DESCRIPTION

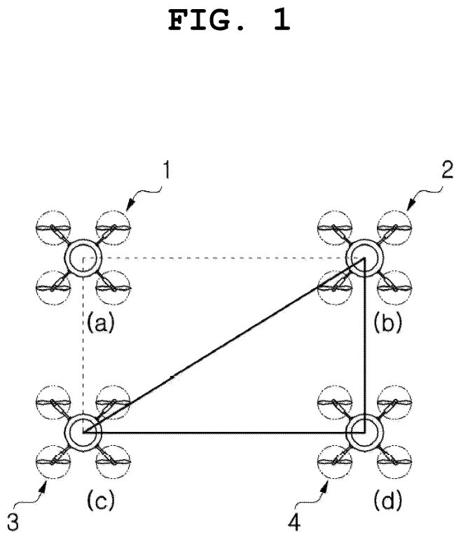

FIGS. 1 to 3 are diagrams conceptually illustrating a precise position method in an environment without a positioning infrastructure using a UWB according to an embodiment of the present disclosure.

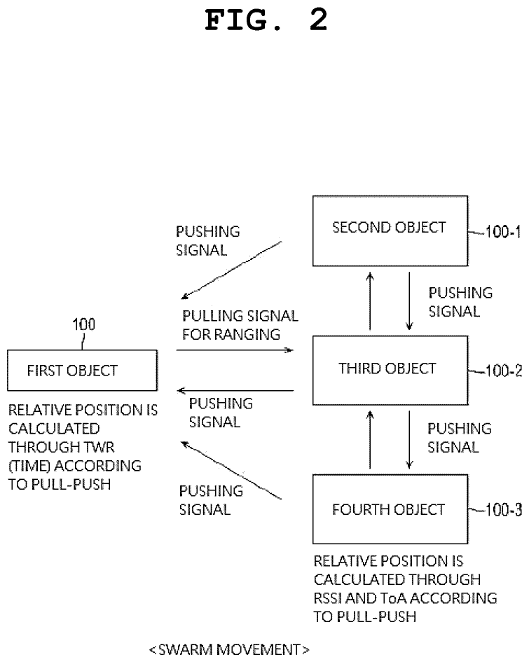

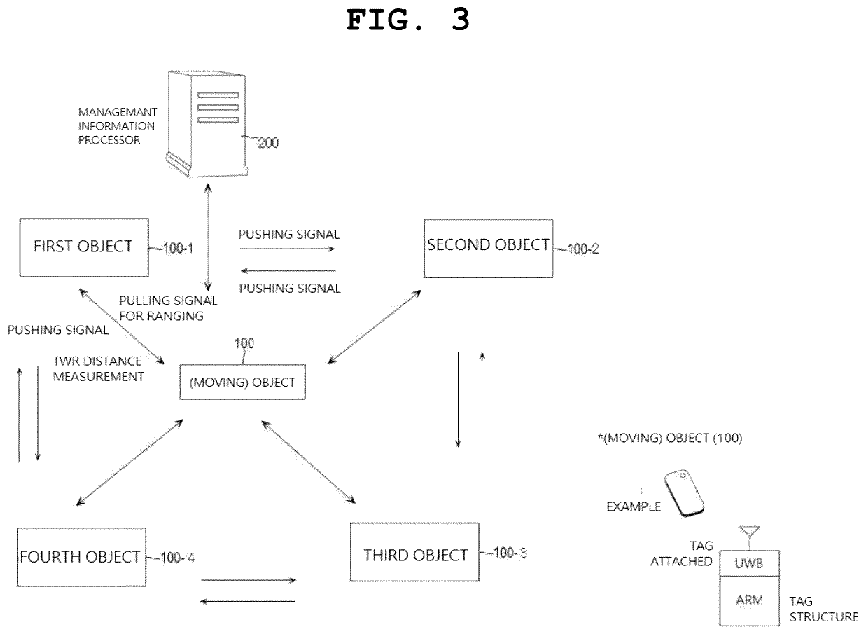

In detail, FIG. 1 is a diagram conceptually showing the positioning method and FIG. 2 is a diagram illustrating the positioning method in a flight space. FIG. 3 is a diagram illustrating the positioning method in an environment with a positioning infrastructure lost.

As shown in FIGS. 1 to 3, a positioning method according to an embodiment performs positioning in a UWB-based cooperative positioning method when performing work in a free flight space, or an environment with a positioning infrastructure lost such as an accident site, thereby providing precise positioning (see FIG.

For example, as in FIG. 1, when work is performed, several flying objects 1, 2, 3, and 4 have a geometric relations in a rectangular plane in swarm flight, thereby forming a formation.

The flying objects 1, 2, 3, and 4 detect relative positions of objects, that is, surrounding flying objects while forming a specific geometric relationship.

In this case, each of the flying objects 1, 2, 3, and 4 detects a flight error by comparing the formation and relative positions of surrounding flying objects.

For example, the first flying object 1 detects a relative position a subject on the basis of a planar triangle structure formed by the other three flying objects 2, 3, and 4. To this end, the first to fourth flying objects transmit and receive information, such as the straight distances, angles, and straight distance ratios of surrounding flying objects to and from each other through wireless communication. For example, when the lengths of corresponding sides of a first right triangle and a second right triangle are compared and are different, it is determined that there is an error in flight of the first flying object 1.

Then, the first flying object 1 corrects the flight error by controlling flight until the lengths of the corresponding sides of the first right angle and the second right angle become the same.

In detail, first, when a swarm object, that is, a swarm moving body is positioned with respect to objects in a free space (see FIG. 1) or an environment with a positioning infrastructure lost (see FIG. 1) as in the related art, objects calculate object positions through cooperation with objects existing around.

In this state, positioning is performed without a specific anchor by defining objects as anchors in a UWB in accordance with an embodiment.

In particular, cooperative positioning is quickly performed by reducing position errors of objects in accordance with pull-push relationships based on UWB TWR.

This cooperative positioning is fundamentally as follows.

First, reference position coordinates are set, a pulling signal is transmitted by preset pull-push relationships according to the TWR of objects around a swarm object, and pushing signals are received from the surrounding objects, whereby ranging is performed.

Thereafter, the relative position of a subject is calculated by the ranged pull-push relationships and TWR time information around the reference position coordinates, and the relative positions of the surrounding objects are generally calculated on the basis of an RSSI (Received Signal Strength Indicator) and ToA information, whereby quick cooperative positioning based on a UWB is provided.

In more detail, this process is as follows.

First, when several different swarm objects are individually moved in an environment without a positioning infrastructure, as in the related art, a controller of each of the swarm objects measures an object position through cooperation with objects existing around, thereby tracking paths.

In this state, a subject position is calculated first on the basis of preset pull-push relationships and TWR time information according to TWR of objects existing around, and a format that generally calculates the positions of surrounding objects on the basis of an RSSI and ToA information is registered.

Then, a pulling signal based on the pull-push relationships is transmitted to surrounding objects in accordance with the format and a pushing signal is received from each of the surrounding objects, thereby ranging is performed.

Accordingly, the relative position of a subject is calculated on the basis of the ranged pull-push relationships and TWR time information.

Every time the relative position of a subject is calculated, the relative positions of surrounding objects are generally calculated on the basis of an RSSI and ToA information, whereby quick cooperative positioning based on a UWB is provided.

For reference, the relative positions of surrounding objects are calculated as follows.

That is, information about the time at which a polling signal and a final signal were transmitted from an object and the time at which a response signal was received from a slave are included in a final signal and transmitted in a message method.

Then, a surrounding object obtains a distance using the time at which the polling signal and the final signal were received, information about the time at which the response signal was transmitted, the time at which the object transmitted the pulling signal and the final signal, and the time at which the response signal was received from the slave.

Further, the relative position of the object is calculated in accordance with the result of combining and operating the distance value and an RSSI value.

Therefore, according to an embodiment, when work is performed in an environment in which a positioning infrastructure does not exist or is lost, such as a free flight space, positioning is performed in the UWB-based cooperative positioning method described above, thereby providing precise positioning.

Accordingly, multi-path tracking and cooperative positioning that are suitable for this environment are provided, and installing and using are easily achieved in cooperation with existing facilities.

Further, when surrounding cooperative targets are positioned, quick cooperative positioning is provided by reducing position errors of the cooperative targets.

For reference, positioning operation for an existing TWR method is schematically described.

First, a TWR method calculates a distance using two packets.

Further, a specific device A transmits a packet showing that ranging is started to a surrounding device.

In this case, the device A measures a roundtrip time t_{round} from the point in time at which the pack was transmitted.

A device receiving the packet from the device A transmits a packet including raging information to the device A after a reply delay time, which is a predetermined time set by a system, as a reply.

The response delay time is a replay delay time for the end of the received packet and the start of the next packet to be transmitted (here, e_{A} is the reply delay time of A and e_{B} is the response delay time of B).

Accordingly, the device A that received the packet estimates a signal arrival time tₚ from the device A to the surrounding device using a reply time t_{reply} and the calculation process in the following Equation 1.

The distance between the device A and the surrounding device is estimated from the estimated signal arrival time.

tₚ=½(t_{round}(1+e_{A})−t_{reply}(1+e_{B})) [Equation 1]

An existing positioning method by ToA is briefly described.

1) First, the operation principle of an RT-ToA method is that, for example, when a transceiver A transmits a signal A, a transceiver B receives the signal A and transmits a signal B that is a replay signal after reception.

2) The transceiver B transmits a value measured on the basis of the time from the point in time of end of the signal A to the point in time of the end of the signal B to the transceiver A. The transceiver B transmits the measurement value to the transceiver A, and an information transmission signal for transmitting the measurement value and a response signal from the transceiver A, that is, additional signals are required two times.

3) ToA=(Tround−Treply)/2 is generally calculated. It is possible to obtain a spatial distance value between the transceiver A and the transceiver B by multiplying the ToA value by a signal transmission speed c of a medium.

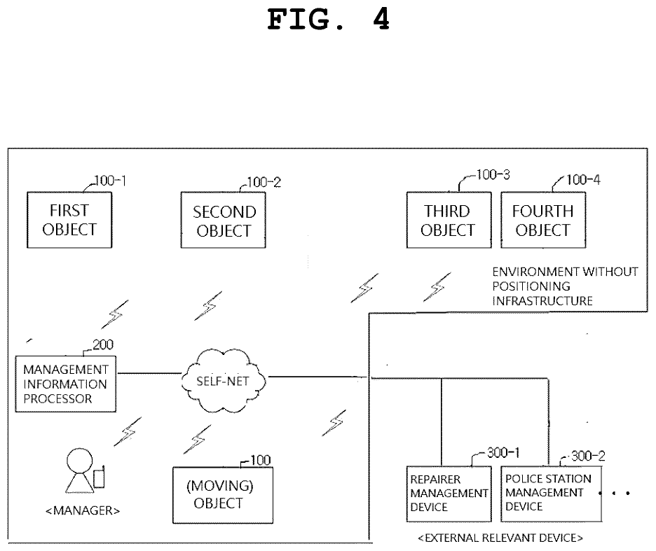

FIG. 4 is a diagram showing the entirety of a system employing the precise position method in an environment without a positioning infrastructure using a UWB according to an embodiment.

As shown in FIG. 4, a system according to an embodiment includes several different swarm objects 100 and a main management information processor 200 (or a manager terminal) that is connected to the swarm objects 100 and tracks and manages objects.

The system further includes, as external relevant devices connected to the main management information processor 200, a repairer management device 300-1 and a police station management device 300-2.

The objects 100 are swarm objects and simply measure a position by only transmitting and receiving information to and from objects existing around using a UWB without a specific anchor, thereby positioning when there are many targets and paths around in a free space, etc.

The main management information processor 200 is connected to the objects 100 and tracks and manages specific targets in accordance with positioning information from the objects 100. To this end, the main management information processor 200 classifies and stores setting information and registration information of various targets several different objects.

Meanwhile, as another embodiment, when a method that does not limit specific positions in a free space, for example, a 3D position of a triangular surveying structure is searched using a UWB as an object for each flying object regardless of anchor/tag. That is, an actual distance is measured through a 2D Real Time Location System (RTLS) or a 3D RTLS. Further, a TWR is used for this triangular surveying.

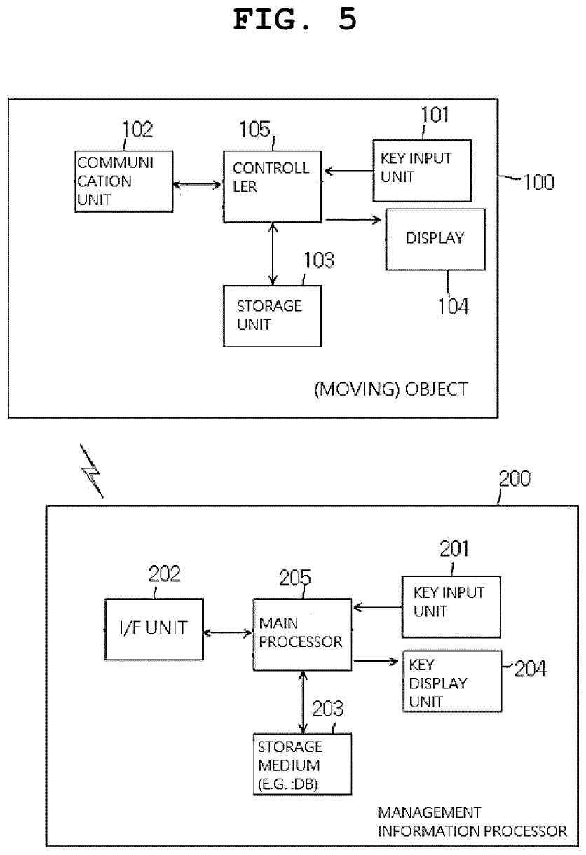

FIG. 5 is a block diagram showing the configuration of an object applied to the precise position method in an environment without a positioning infrastructure using a UWB according to an embodiment.

As shown in FIG. 5, the objects 100 applied to the precise position method in an environment without a positioning infrastructure using a UWB each includes, in a broad meaning, a key signal input unit 101, a communication unit 102, a storage unit 103, a display 104, and a controller 105.

The main management information processor 200 applied to the positioning method includes, in a broad meaning, a key signal input unit 201, an I/F unit 202, a storage medium 203, a display 204, and a main processor 205.

The key signal input unit 101 receives input of various items of user setting information and registration information (e.g., device registration information) for the positioning according to an embodiment. For example, the key signal input unit 1010 receives input of a setting format. The setting format, as described above, calculates a subject position on the basis of preset pull-push relationships and TWR time information according to TWR of objects existing around, and generally calculates the positions of the surrounding objects on the basis of an RSSI and ToA information.

The communication unit 102 transmits and receives information to and from objects existing around such that relative positions of objects are calculated, as described above.

The storage unit 103 is controlled to separately store various items of setting information and registration information for positioning according to an embodiment in accordance with objects.

The display 104 is controlled to display various items of guide information including positioning information according to an embodiment.

The controller 105, which controls the component described above, performs positioning on the basis of a pull-push relationship on the basis of a UWB TWR. In detail, the controller, in accordance with the set format, transmits a pulling signal on the basis of preset pull-push relationships according to the TWR of objects existing around, and receives pushing signals from the surrounding objects, thereby performing ranging. Thereafter, the controller calculates a relative position of a subject on the basis of the ranged pull-push relationships and TWR time information around the reference position coordinates, and generally calculates the relative positions of the surrounding objects on the basis of an RSSI and ToA information.

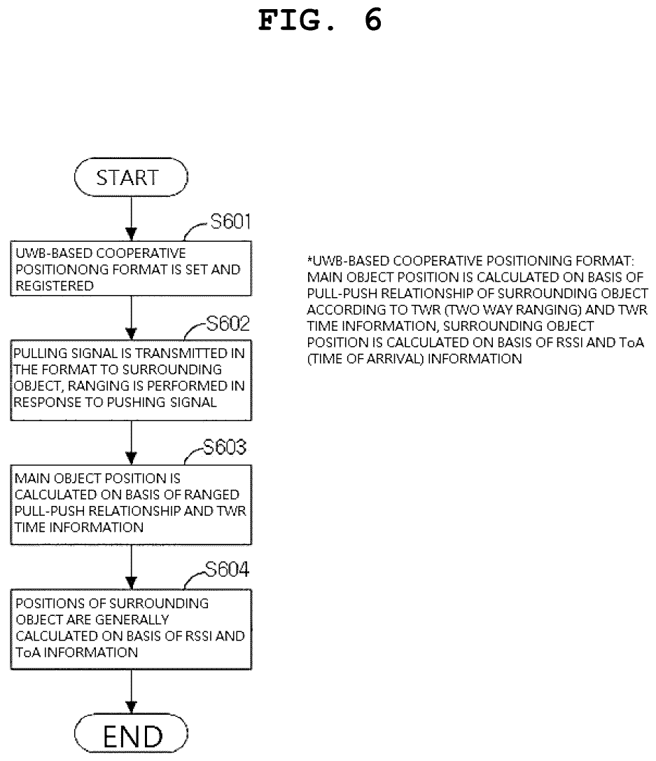

FIG. 6 is a flowchart sequentially showing the precise positioning method in an environment without a positioning infrastructure using a UWB.

As shown in FIG. 6, in the positioning method according to an embodiment, when several different swarm object are individually moved in an environment without a positioning infrastructure, as in the related art, a controller of each of the swarm objects measures an object position through cooperation with objects existing around, thereby tracking paths.

In this state, in accordance with an embodiment, a subject position is calculated on the basis of preset pull-push relationships and TWR time information according to TWR of objects existing around, and a format calculating the positions of the surrounding objects on the basis of an RSSI and ToA information is registered (S601).

Next, the type of an environment without a positioning infrastructure is set and registered in accordance with environment type setting information that is input by user key operation. The type of an environment without a positioning infrastructure, for example, is classified and set as an environment in which a positioning infrastructure does not exist or is lost.

Then, a pulling signal based on the pull-push relationships is transmitted to the surrounding objects in correspondence to the types of environments without a positioning infrastructure in accordance with the format and a pushing signal is received from each of the surrounding objects, whereby ranging is performed (S602).

Accordingly, a relative position of a subject is calculated on the basis of the ranged pull-push relationships and TWR time information (S603).

Every time the relative position of a subject is calculated, relative positions of surrounding objects are generally calculated on the basis of RSSI and ToA information (S604), whereby quick cooperative positioning based on a UWB is provided.

Therefore, according to an embodiment, when work is performed in an environment in which a positioning infrastructure does not exist or is lost, such as a free flight space, positioning is performed in the UWB-based cooperative positioning type described above, whereby precise positioning is performed.

Accordingly, multi-path tracking and cooperative positioning that are suitable for this environment are provided, and installing and using are easily achieved in cooperation with existing facilities.

Further, when cooperative targets existing around are positioned, quick cooperative positioning is performed by reducing position errors of the cooperative targets.

As another embodiment, when the relative position of a subject and the relative positions of the surrounding objects are calculated, directionality is provided to each of the relative positions using an RSSI variation value according to Doppler frequency shift obtained from the ranged pull-push relationships information. That is, direction values are calculated on the basis of direction information using Doppler principle between transmission and reception signals for ranging, that is, Doppler frequency shift information.

Accordingly, these values are combined and operated with the relative positions, whereby direction information is provided.

Meanwhile, a fingerprint map is configured from a pre-registered radio wave map information base on the basis of an RSSI according to the several different pull-push relationships described above, and the relative position of the object and the relative positions of the surrounding objects are applied to the fingerprint map, thereby providing easily recognizable information.

For example, a radio wave map DB for ranging classifies positions for each of RSSI levels according to pull-push relationships.

As described above, according to an embodiment, first, when an object of swarm objects is positioned, as in the related art, the object position of each of the objects is calculated through cooperation with objects existing around.

In this state, positioning is simply performed without a specific anchor by defining objects as anchors in a UWB in accordance with an embodiment.

In particular, UWB-based cooperative positioning is quickly performed by reducing a position error of the object in accordance with a pull-push relationship based on UWB TWR.

Fundamentally, reference position coordinates are set, a pulling signal is transmitted by preset pull-push relationships according to the TWR of objects existing around, and a pushing signal is received from each of the surrounding objects, whereby ranging is performed.

Thereafter, the relative position of a subject is calculated by the ranged pull-push relationships and TWR time information around the reference position coordinates, and the relative positions of the surrounding objects are generally calculated on the basis of an RSSI and ToA information, whereby quick cooperative positioning based on a UWB is provided.

Therefore, according to an embodiment, when work is performed in an environment in which a positioning infrastructure does not exist or is lost, such as a flight space, positioning is performed in the UWB-based cooperative positioning method described above, whereby precise positioning is performed.

Accordingly, multi-path tracking and cooperative positioning that are suitable for this environment are provided, and installing and using are easily achieved in cooperation with existing facilities.

Further, when cooperative targets existing around are positioned, quick cooperative positioning is provided by reducing position errors of the cooperative targets.

Meanwhile, additionally, according to this positioning method, as another embodiment, an error may be generated due to hiding of a sensor, reflection of radio waves, etc. in wireless range measuring. Accordingly, positioning is performed except for wrong measured range values of the ranges measured for anchors to achieve precise positioning (e.g., a method that is used in an accident site, etc.).

In detail, a pulling signal based on the pull-push relationships is transmitted to surrounding objects in accordance with the format described above and a pushing signal is received from each of the surrounding objects.

Next, range sets are formed in accordance with a predetermined number, and distance and speed information of surrounding objects of all the received information.

For example, when there are four surrounding objects, a reception range is intactly used in a first loop, and four sets are selectively formed in a second loop. For example, {1234} is intactly used in the first loop and four lists of {123, 124, 134, 234} are formed in the second loop.

Estimated coordinates are calculated for each of the range sets in accordance with the format.

Next, an error range is calculated for each of the range sets as the result of subtracting the ranged values (absolute values) from the calculated estimated coordinates and the distances of the surrounding object positions.

Further, an estimated speed is calculated for each of the range sets having the calculated error ranges. That is, ‘distance difference of estimated coordinates and immediately previous coordinates/difference of measured time and immediately previous time’ is calculated.

Accordingly, range sets to be positioned are formed by selecting range sets in which the error range has a minimum error range within a preset allowable error range and the estimated speed is within a preset allowable speed.

As a result, positioning according to an embodiment is performed for the range sets.

Accordingly, an error may be generated due to hiding of a sensor, reflection of radio waves, etc. in wireless range measuring in another embodiment, but, in order to solve this problem, positioning is performed except for wrong range values of the ranges measured for anchors, thereby providing precise positioning.

Further, UWB-position tracking precision in actual field rather than a laboratory (indoor) level is improved, whereby it is possible to check and gives a warning about whether work, etc. are being performed well on the basis of such position.

Meanwhile, as another embodiment, when ranging described above is performed, this positioning method recognizes a position from the following distance measurement format to correspond to a pull-push relationship, whereby ranging is performed to correspond to a cooperative characteristic, and accordingly, quicker cooperative positioning is provided.

In detail, first, a pulling signal based on the pull-push relationship information is formed in a setting instruction type and transmitted to objects existing around, thereby instructing the surrounding object to report.

Accordingly, an object and surrounding object have a user memory in which the pull-push relationship information is recorded, so when the surrounding objects receive the pulling signal, they report to the object by returning a pushing signal in an event driven type through the user memory.

Further, every time ranging is performed through the user memory, a preset user memory address is read out when the surrounding objects receive a pulling signal, whereby operation of continuously writing different pushing signals for pull-push relationships, respectively, in the user memory is repeatedly performed. Accordingly, relative positions are calculated through pull-push information.

Further, the operation of reading out and writing data according to the pull-push relationships is performed in correspondence to the distances between objects, thereby obtaining pull-push rate information.

Accordingly, the positioning method according to an embodiment, when performs quick cooperative positioning based on a UWB, performs ranging to correspond to the cooperative characteristic in this way, and accordingly, further reduce position errors of objects, thereby providing quicker cooperative positioning

In terms of another side, another way that is used in the positioning method according to an embodiment of described.

For example, a position is measured through triangular surveying using TWR described above in accordance with an existing method, it is attempted to reduce an error due to a clock difference between two nodes of a transmission part and a reception part in the following way.

To this end, such positioning, when the position of an object (or a flying object) is quickly tracked, compensates for the clock difference between two nodes on the basis of symmetric double-sided TWR, thereby reducing an error.

In this case, in the TWR, a processor satisfies Request>ACK+Request>ACK>DATA Report. Further, ToF is {(t_{roundA}−t_{replyA})+(t_{roundB}−t_{replyB})}/4. Accordingly, the clock difference between two node is compensated through such additional message exchange, whereby an error is reduced.

For reference, in an existing TWR, a processor satisfies Request>ACK and ToF is (t_{roundA}−t_{reply})/2. Accordingly, an error may be generated duet to a clock difference between two nodes and many tags may be available through less packet exchange.

In particular, in addition to the existing way, when relative positions are all calculated in accordance with an embodiment, a clock difference between two nodes is compensated through symmetric double-sided TWR corresponding to the pull-push relationships described above, whereby errors are appropriately reduced for pull-push relationships, respectively.

For reference, in the case in which an object (including a flying object) is made, when the same antennas and an electrode distance from an antenna to a MMIC chip are used and the same processors and signal processing programs are used, a reception delay is fundamentally caused, whereby an error is minimized in the way described above.

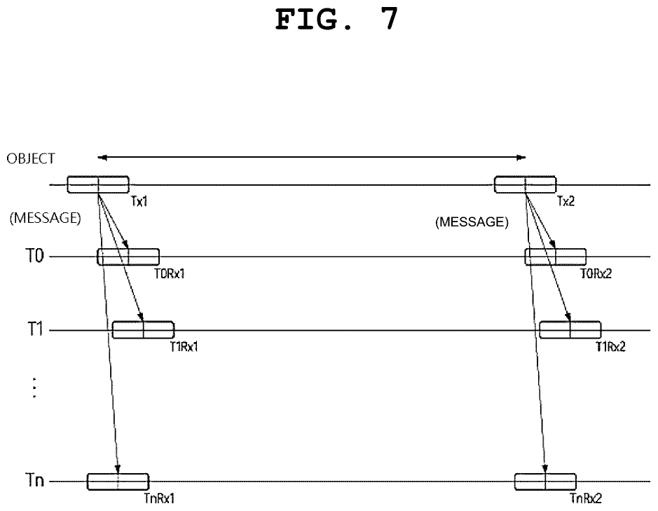

FIG. 7 is a diagram illustrating a precise position method in an environment without a positioning infrastructure using a UWB according to another embodiment of the present disclosure.

As shown in FIG. 7, a positioning method according to another embodiment is performed through a position information obtaining process by an SDS TWR type.

In this case, TWR performs positioning by calculating a distance while transmitting and receiving a plurality of packets between objects or flying objects.

Further, there is an advantage in comparison to Time and Direction of Arrival (TDOA) that there is no need for clock synchronization between objects and accuracy of outdoor positioning is high. Further, the TWR type obtains distances from three or more surrounding objects and calculates through trigonometry.

In detail, this TWR type is SDS-TWR.

First, when a specific object transmits a pulling packet to a surrounding object, the specific object receives a pushing packet as a reply.

When the specific packet transmits again a final packet, a distance is calculated on the basis of time values of each of the packets.

In this case, a pulling Tx time (Poll Tx time), a pushing Rx time (Resp Rx Time), and a final Tx time (Finale Rx Time) are carried with the final packet.

Accordingly, a distance value is calculated on the basis of a total of six time values (response Tx time (Rsep Tx Time), final Rx time (Finale Rx Time), and response Rx time (Resp Rx Time)) by summing up three times sent with the final packet.

In this case, the distance value is calculated as in the following Equation 2.

distance=speed of light×((Resp RX Time−Poll Tx Time)−(Resp TX Time−Poll Rx Time)+(Finale RX Time−Resp TX Time)−(Finale Tx Time−Resp RX Time))/4 [Formula 2]

Meanwhile, a direction angle calculation method that is additionally applied to such an information obtaining process is as follows.

First, each object checks the distance obtained by the SDS-TWR way through the UWB communication described above.

Next, when SDS-TWR is performed, for example, two pairs of sets positioned separately by a vertical axis and a horizontal axis in a plane are set from four objects.

Direction angles between the two objects of each of the pairs and a surrounding object are calculated, whereby two items of direction angle information, that is, first direction angle information and second direction information are obtained. That is, direction angles are calculated for the sets of two objects having a long distance of the four objects.

In this case, a smoothing effect may be applied by performing Kalman filer to the calculated direction angle.

Next, weight is applied to a direction angle of which the inter-axis angle is close to verticality of these two calculated direction angles, and then an average of the two direction angles is calculated.

Accordingly, a direction angle calculation method that is used in the position information obtaining described above is performed.

Further, such a time profile is described. For reference, a time profile shows an action of an object.

In detail, first, a specific object transmits two signals Tx₁ and Tx₂ with a predetermined interval. Then, several surrounding objects receive the two signals Rx₁ and Rx₂, in which intervals are the same.

Further, the signal transmission interval ΔTx of the specific object is as in the following Equation 3.

ΔTx=Tx₂−Tx₁ [Equation 3]

Next, the signal transmission intervals ΔRx of the surrounding object are as in the following Equation 4.

ΔRx=Rx₂−Rx₁ [Equation 4]

Then, when the clock that is used in the specific object and the clocks that are used in the surrounding objects are the same, ΔTx and ΔRx are fundamentally the same.

However, rather than clocks that are used in objects, oscillators in the clocks are substantially different in frequency, so ΔTx and ΔRx are different.

Accordingly, a skew of the clock of a reception part from a transmission part is as in the following Equation 5.

skew=ΔRx/ΔTx [Equation 5]

Meanwhile, the transmission part transmits two transmission signals including a message of transmission time with a predetermined interval through transmission delayed by a delay time To.

Then, the reception part records a reception time and the difference of the clock of the reception part from the clock of the transmission side is obtained as in the following Equation 6.

skew=(ToR₂−ToR₁)/(ToT₂−ToT₁) [Equation 6]

Accordingly, when the difference of the reception part is known later, an accurate position is calculated by correcting the time at the transmission side, which is the reference of positioning, with the reception time.

Further, a situation in which such a positioning type is used is described through an example.

First, when n (n is a certain integer) objects (or unmanned swarm flying objects) performs work and at least one object of the objects moves a predetermined distance away from the relative position described above, etc., the object transmits an alarm signal.

In particular, an alarm signal that is appropriately used for unmanned flying objects and showing a change of a flight path is transmitted.

Objects are referred to as flying objects hereafter.

Next, a flying object corresponding to the specific object searches surrounding flying objects having a possibility of a collision.

Further, flying paths are interactively adjusted until the number of flying objects having a possibility of a collision becomes 0.

Accordingly, the flight paths of n flying objects when the number of flying objects having a possibility of a collision is 0 are decided.

Accordingly, the flying objects all change their flight paths into the decided flight paths.

Such a collision avoidance method includes a process in which when at least one unmanned flying object suddenly changes its flight path, other unmanned flying objects correspondingly change their flight paths, whereby the flight paths of n unmanned flying object that are in flight are optimized.

that is, even though several unmanned flying objects are flying though designated paths, a sudden situation may occur, so the flight paths of the unmanned flying objects are interactively adjusted using this method, thereby easily coping with a sudden situation.

In particular, the unmanned flying vehicle that changed first its flight path may have performed avoidance maneuver to rapidly avoid obstacles. Accordingly, the initial avoidance maneuver is maintained by interactively adjusting the flight paths of the other unmanned flying objects, whereby the flight paths of all of the n unmanned flying object that are in flight are optimized.

Accordingly, several unmanned flying objects that are flying at a distance or in a swarm in a flight area are prevented from colliding with each other or another object and are effectively controlled.

Further, the n unmanned flying objects may fly while communicating with a control station. The n unmanned flying objects and the control station exchange information through a wireless communication method. The unmanned flying objects each have individual flying ability and fly in desired directions along their programmed flight paths while communicating with the control station.

Then, the control station observes the flight situations of the unmanned flying objects by receiving the information and monitors the areas in which the unmanned flying objects are flying, or accumulates relevant data. In this case, the control station, depending on cases, transmits additional information or gives an instruction to change a flight path to perform specific work.

As described above, at least one of the n unmanned flying objects that are in flight may meet an obstacle and transmits an alarm signal showing that its flight path is changed. In this case, the obstacle may be a thing that is not shown in the flight path and suddenly appeared.

Accordingly, the unmanned flying object sensing the obstacle performs an obstacle avoidance process for quickly avoiding the obstacle. Accordingly, there may be a problem that the flight paths of the unmanned flying objects interfere with each other.

Accordingly, the unmanned flying object that has transmitted an alarm signal immediately changes its flight path through the obstacle avoidance process and then transmits an alarm signal, or transmits an alarm signal and then changes its flight path. That is, the unmanned flying object performs avoidance maneuver first to quickly avoid the obstacle and then informs the control station of this fact.

Further, when an obstacle is sensed at an appropriate distance, an unmanned flying object transmits an alarm signal before starting avoidance maneuver or even while performing avoidance maneuver. In this case, the location, speed, flight path, etc. of the unmanned flying object are provided together.

Accordingly, when the flight path of the unmanned flying object is calculated, unmanned flying objects having a possibility of a collision are searched for by comparing the flight paths of all of the n unmanned flying objects with each other.

For example, unmanned flying objects having a possibility of a collision are searched for by generally considering not only the flight paths of the unmanned flying objects, but the entire flight information, the sizes of the unmanned flying objects, etc. In this case, there may be a possibility of a collision even due to small airflow variation, etc., depending on the degree of proximity of the changed flight path of the unmanned flying object that has transmitted an alarm signal and the flight paths of the other unmanned flying objects.

Accordingly, unmanned flying objects having a possibility of a collision are found out in consideration of this factor. Further, unmanned flying objects having a possibility of a collision are searched for by comparing the flight paths of the n unmanned flying objects with each other in this way.

Further, when an unmanned flying object having a possibility of a collision is found, the flight paths of the other unmanned flying objects other than the unmanned flying object that has transmitted an alarm signal are interactively adjusted until the number of unmanned flying objects having a possibility of a collision becomes 0.

In detail, the avoidance maneuver for avoiding an obstacle of the unmanned flying object that has performed first avoidance maneuver is maintained, the flight paths of the other unmanned flying objects are adjusted, and additional collision possibilities are removed.

Accordingly, additional secondary and third collisions that may be generated due to the flight path change by avoidance maneuver and adjustment of the flight paths are prevented, and the several unmanned flying objects are controlled to fly through more optimized flight paths.

Meanwhile, even though unmanned flying objects fly across each other, for example, in opposite directions, the flight paths can be easily adjusted and optimized.

For example, it is possible to adjust the flight paths of the other unmanned flying objects including an unmanned flying object having a possibility of a collision such that even unmanned flying objects that are flying in opposite direction have the same variation range as the initial flight path variation range.

Accordingly, flight paths are set to avoid not only a collision of the unmanned flying objects, but a collision between the unmanned flying objects and an obstacle.

Further, the process of adjusting the flight paths of unmanned flying objects includes a process of avoiding a collision by at least one of horizontally or vertically changing the paths of unmanned flying objects at a point at which unmanned flying objects having a possibility of a collision will meet each other. That is, when an unmanned flying objects that has avoided first an obstacle interferes with the flight path of an adjacent unmanned flying objects by horizontally moving, flight paths are changed such that the adjacent unmanned flying object vertically changes its flight path to avoid unmanned flying objects that interfere with its flight path.

Accordingly, variation of the flight paths of all of the unmanned flying objects is minimized.

Further, another operation of avoiding an obstacle is additionally described.

In detail, when an obstacle is selected while an unmanned flying object is in flight through remote control, the flight direction is automatically changed.

That is, an unmanned flying object generates radio wave to the outside in real time while flying. In this case, it is determined whether a reflective wave of the radio wave is received.

When a reflective wave is sensed, that is, the radio wave is reflected and received by an obstacle, the distance from the obstacle is calculated. Next, a collision with the obstacle is predicted in consideration of calculated distance, the speed of the unmanned flying object, etc.

For example, when the obstacle is in a critical range as the result of calculating the distance from the obstacle, it is predicted that a collision will occur.

Next, when an obstacle is sensed, flight by remote control is stopped and an unmanned flying object changes the flight direction into the opposite direction.

Next, when a predetermined time (e.g., 2˜5 seconds) passes after the unmanned flying object changes the flight direction into the opposite direction, the unmanned flying object allows for operation by remote control.

Further, this positioning method is performed as follows and performs ranging scheduling in the following way, thereby providing more function.

First, when the location of a flying object is calculated, a master flying object that is a reference is determined, and locations are calculated by measuring the distances between surrounding slave flying objects around reference coordinates through Two Way Ranging (TWR), whereby the relative positions of the flying objects are calculated.

Next, operation is as follows.

First, a master node divides a preset frame and designates the frame segments to slave nodes. In this case, the frame is s preset interval and the master node may divide the frame into slave transmission times for the slave nodes. Further, the master node can designate slave transmission times to the slave nodes, respectively. Further, the master node creates scheduling information as the result of scheduling.

Next, the master node transmits the scheduling information. In this case, the scheduling information may further include identification information of the master node and the slave nodes. Further, the master node can insert a beacon message into the scheduling information and then transmit the scheduling information. The beacon message is for time synchronization in a location tracking system. Further, the master node can emit a beacon message. Alternatively, the master node may transmit a beacon message using the identification information of tag nodes and slave nodes.

Further, in a method of a communication system and coordinates, a frame for positioning may be achieved by variously setting slots.

For example, a frame for positioning has slots corresponding to the number of masters, and for example, when there are three masters, a frame is composed of three slots. Further, each master controls one slot.

In this case, the slot may be composed of an initialization period and a slave positioning period.

What is claimed is:

1. A positioning method using ultra-wideband (UWB), in which when several different swarm objects are individually moved, a controller of each of the swarm objects measures an object position by cooperating with surrounding objects to be able to track paths, the method comprising:
a first step of calculating a subject position on the basis of TWR information and a predetermined pull-push relationship according to Two-Way Ranging (TWR) of the surrounding objects, and registering a format calculating surrounding object positions on the basis of Received Signal Strength Indicators (RSSI) and Time of Arrival (ToA);
a second step of receiving, and setting and registering the types of environments without a positioning infrastructure of the swarm objects in accordance with environment type setting information that is input by user key operation;
a third step of staring positioning operation on the swarm objects in accordance with movement;
a fourth step of setting reference coordinates of the swarm objects in accordance with the positioning operation performed in the third step;
a fifth step of transmitting a pulling signal to the surrounding objects on the basis of the pull-push relationship to correspondence to the environment types without a positioning infrastructure by the second step in accordance with the format registered by the first step;
a sixth step of receiving a pushing signal from each of the surrounding objects and performing ranging in accordance with the pulling signal transmitted by the fifth step;
a seventh step of calculating a relative position of a subject around the reference coordinates by the fourth step on the basis of TWR time information and the pull-push relationship ranged by the sixth step; and
an eighth step of generally calculating relative positions of the surrounding objects every time a relative position of a swarm object is calculated by the seventh step.

2. The method of claim 1, wherein the seventh step and the eighth step provide directionality to each relative position using an RSSI variation value according to Doppler frequency shift from the ranged pull-push relationship information when calculating the relative position of a subject and the relative positions of the surrounding objects.

3. The method of claim 2, wherein the fifth step comprises:
a 5-1 step of transmitting a pulling signal to the surrounding objects on the basis of the pull-push relationship to correspondence to the environment types without a positioning infrastructure by the second step in accordance with the format registered by the first step;
a 5-2 step of receiving a pushing signal from each of the surrounding objects in accordance with the pulling signal transmitted by the 5-1 step;
a 5-3 step of forming a range set in accordance with a predetermined number, and distance and speed information of the surrounding objects of all the information received by the 5-2 step;
a 5-4 step of calculating estimated coordinates for each of the range sets formed by the 5-3 step in accordance with the format;
a 5-5 step of calculating an error range for each of the range sets as the result of subtracting the ranged values from the estimated coordinates calculated by the 5-4 step and distances of the surrounding object positions;
a 5-6 step of calculating an estimated speed for each of the range sets having the error ranges calculated by the 5-5 step; and
a 5-7 step of forming range sets to be positioned by selecting range sets in which the error range calculated by the 5-6 step has a minimum error range within a preset allowable error range and the estimated speed calculated by the 5-5 step is within a preset allowable speed.

4. The method of claim 3, further comprising:
a ninth step of configuring a fingerprint map from a pre-registered radio wave map information base on the basis of an RSSI according to several different pull-push relationships, and of applying the calculated relative position of a subject and the calculated relative positions of the surrounding objects to the fingerprint map, after the eighth step.

5. The method of claim 4, wherein the fifth step of forming and transmitting a pulling signal by the pull-push relationship information into a setting instruction type to objects existing around in correspondence to the types of environment without a positioning infrastructure y the second step in accordance with the format registered by the first step, thereby instructing the surrounding object to report, and
wherein the sixth step in which the subject and the surrounding objects each have a user memory in which the pull-push relationship information is recorded, so when the pulling signal is received, an object is reported by returning a pushing signal in an event driven type through the user memory.
